(19) United States
(12) Patent Application Publication
(10) Pub. No.: US 2013/0055964 A1
(43) Pub. Date: Mar. 7, 2013

(54) Pet Grooming Device

(71) Applicant: Margaret Brady, Huntington, NY (US)

(72) Inventor: Margaret Brady, Huntington, NY (US)

(21) Appl. No.: 13/586,404

(22) Filed: Aug. 15, 2012

Related U.S. Application Data
(60) Provisional application No. 61/575,153, filed on Aug. 15, 2011.

(51) Int. Cl. A01K 13/00

(52) U.S. Cl. 119/611

(57) ABSTRACT

A pet grooming device comprising a brush with holes present on the bristle side that collect loose hair or fur. A vacuum motor, housed within the brush pulls the hair or fur through the holes into a reservoir which can be emptied when full.

### CROSS-REFERENCE TO RELATED APPLICATIONS

The present application claims priority under 35 USC 119 (e) (1) from U.S. Provisional Patent Application, Ser. No. 61/675,153, filed Aug. 15, 2011, for No Mess-Hassle Free Brush, of common inventorship.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention pertains to the field of pet accessories, and more specifically to the field of pet grooming devices.

### BACKGROUND OF THE INVENTION

Millions of consumers enjoy the companionship and unrequited love afforded by a pet dog or cat. Because dogs and cats are more often considered a member of the family, most owners provide adequate shelter, a healthy diet and a regular routine for grooming their animals. Regularly brushing an animal's coat is an important part of pet ownership. Regular brushing prevents painful matts from occurring and facilitates a smooth and shiny coat. Grooming gives the pet positive human interaction and promotes a strong bond and loyalty to their owners. Brushing an animal's coat helps control shedding. Most animals shed their fur naturally as their coat is replaced with new hair follicles. Many dogs go through a process called blowing the coat, which usually takes place twice per year. The dog's fur is replaced in to accommodate changing seasons and temperatures. Brushing the animal's fur greatly reduces the time it takes for this process to complete. A major drawback associated with brushing one's pet is dealing with the loose fur that blows about while the brushing the coat. The simple act of brushing the animal results in the pet owner and surrounding furnishings being completely covered in stray hairs. Many pet owners resort to brushing their animals outdoors, to spare themselves the messy clean up associated with brushing their animals inside. During the cold winter months and rainy months of spring, brushing a pet outdoors is an uncomfortable and unpleasant task. The prior art has put forth several designs for pet grooming devices.

U.S. Pat. No. 5,211,131 to Chun A. K. Plyler describes pet grooming device that includes a vacuum system for removing fleas, ticks, loose hair and other debris from a cat or a dog. It is a hand held device with a detachable head comprised of bristles for brushing.

U.S. Pat. No. 5,074,006 to Nunzio Eremita describes a pet vacuum comb to quickly remove fleas, ticks, loose hair and debris from a pet's coat. The device utilizes a housing unit with spaced apart tines on the front end. The middle and back ends comprise a vacuum system followed by a removable canister to collect the debris.

U.S. Pat. No. 4,799,460 to Lynn Kuhl describes a light weight, battery operated portable unit designed and utilized as a vacuum cleaner for pets. It is a cylindrically shaped unit with a front end containing a circular brush followed by a middle section housing a vacuum fan and electrical components. An end section contains a battery compartment and a canister for collecting a pet's debris.

None of these prior art references describe the present invention.

### SUMMARY OF THE INVENTION

It is an object of the present invention to provide an improved animal grooming brush specially designed for collecting and containing loose hairs brushed from a pet's shedding coat.

### BRIEF DESCRIPTION OF THE DRAWINGS

FIG. 1 is a perspective view of the top side of a first embodiment of the present invention showing soft bristles, holes on the top of the brush and battery storage area in the handle.

FIG. 2 is a perspective view of the bottom side of the first embodiment shown in FIG. 1 showing the see through hair receptacle.

FIG. 3 is a perspective view of the top side of the first embodiment shown in FIGS. 1 and 2 showing how the soft bristled brush top detaches from the canister to allow elimination of the collected hair into a trash receptacle.

FIG. 4 is a side perspective view of an alternative embodiment of the present invention standing on one end, showing a handle on the back side and a brush on the front side.

FIG. 5 is a perspective back view of the embodiment shown in FIG. 4 standing on one end, showing a canister for holding pet hair and handle for holding the brush.

FIG. 6 is a perspective front view of the embodiment shown in FIGS. 4 and 5 standing on one end, showing hair suction holes and a battery storage area.

### DETAILED DESCRIPTION OF THE INVENTION

The present invention, a pet grooming device is a grooming brush designed to capture loose fur or hair as it is brushed free from the animal, preventing this loose hair from coating the groomer and their surroundings.

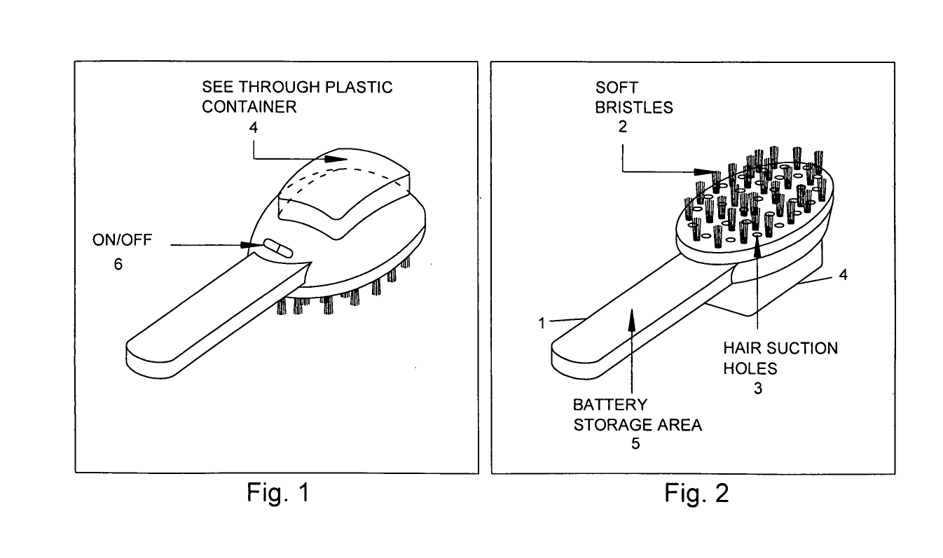

In a first embodiment of the present invention, the head of the brush is oval in shape with an elongated, ergonomically designed handle attached to the base of the brush head. This first embodiment of the present invention is shown in FIG. 1. The first embodiment of the present invention, as shown in FIG. 1, comprises an elongated handle [1], bristles [2] and holes [3] on the top side of the brush head. Loose hair or fur from the animal is pulled through these holes [3] by a vacuum, not shown, housed in the brush. Still referring to FIG. 1, a hair reservoir [4] on the bottom of the brush for containing the loose hair or fur is shown. Further as shown in FIG. 1, a battery compartment [5] is housed in the handle. Batteries housed in this compartment powers the small vacuum motor also housed in the handle (not shown).

FIG. 2 shows the bottom side of the first embodiment of the present invention. The hair reservoir [4] is on the bottom side of the brush and interlocks with the top side, or in the alternative, is hinged to the top side of the brush to enable the reservoir to be emptied easily. An on/off switch [6] is also shown on the bottom side of the handle. This switch turns the vacuum motor on and off.

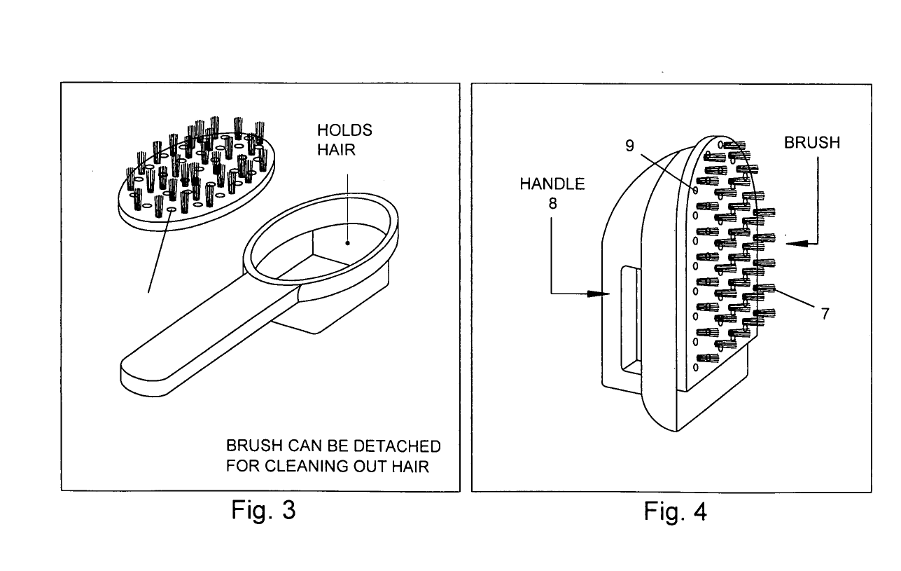

As shown in FIG. 3, a plastic covering encompasses the back of the brush head, from which the user empties the reservoir following use. This covering contains an interlocking or comparable fastener.

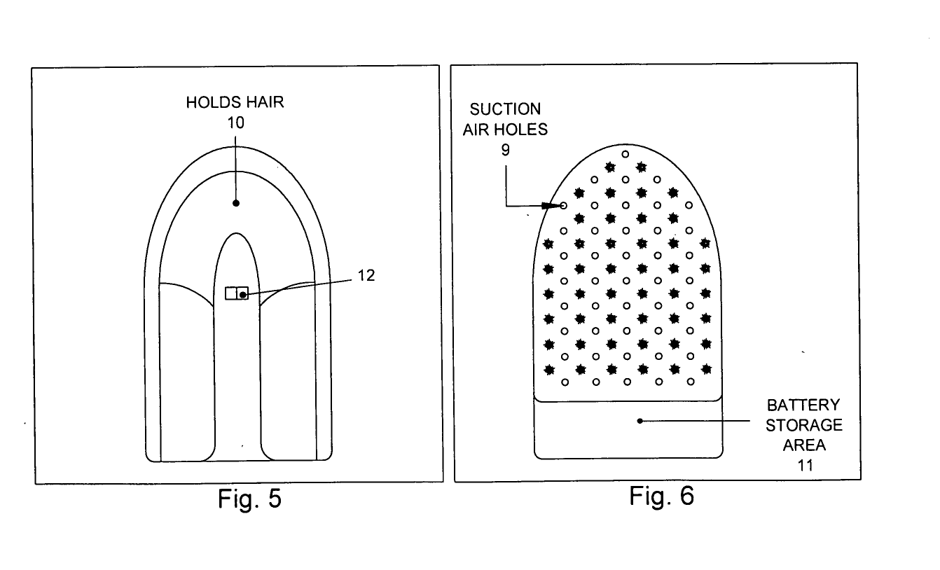

FIGS. 4, 5 and 6 illustrate a second embodiment of the present invention. Referring specifically to FIG. 4, in this second embodiment the bristles [7] are attached on a front side of the brush with the handle [8] being on the opposite back side. As in the first embodiment, holes [9] are present on the bristle or front side of the brush, as seen in FIG. 6. As shown in FIG. 5, the hair is collected in the interior of the brush and a door [10] serves to allow the user to empty hair. The battery compartment [11], shown in FIG. 6, and vacuum motor, not shown, are housed in the base of the brush in this second embodiment. As seen in FIG. 5, an on/off switch [12] switches the vacuum on and off.

The present pet grooming device may be produced in a variety of sizes to fit different animal sizes. Bristles may be either metal tines or fiber bristles. The brush itself may be manufactured primarily of plastic, metal or any other suitable material. An additional consideration for this unit is to contain a rechargeable internally contained battery which can be recharged by plugging the unit into an electrical outlet.

Using the present pet grooming device is very simple. The user purchases the device in the size and style appropriate for their animal's fur. An Old English Sheep dog may require a large brush with wire tines to brush through its thick coat. A Siamese cat may need a brush with soft bristles for its silky fur. After purchase, the user loads batteries into the battery compartment or charges a rechargeable battery contained within the unit. Grasping the brush in hand, the user activates the unit's vacuum or internal suction mechanism by turning the switch [6] or [11] to on. As the user brushes the animal, the device suctions and collects the animal fur into the hair reservoir. After grooming the animal, the user opens the covering which encompasses the collection reservoir and empties the animal fur into any trash receptacle. The user then stores the device until future use.

This pet grooming device provides pet owners with a simple and sanitary means to groom their pet. Pet owners brush their animals without becoming covered in fur themselves or having the debris settle on to furnishings, carpeting and other household items. Containing this fur and dander prevents pet owners from suffering allergic symptoms such as itchy eyes and runny nose while grooming their pets. Consumers can stay inside to administer this pampering treatment of their pet, facilitating a healthy, shiny coat while also creating a natural bond between the animal and pet owner. The device may be operated easily by adults and children. It may be used by individual pet owners or professional pet groomers or kennel staff. Durably constructed of quality materials, this device may withstand years of repeated use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

I claim:

1. A device comprising a brush, wherein the bristles are connected to a first side of the brush, wherein holes are present on this first side, wherein a second side is hinged to the first side, wherein a vacuum motor, housed within the brush, pulls air and other debris through said holes.

2. A device comprising an oval brush, a handle, and bristles, wherein the bristles are connected to a first side of the brush, wherein holes are present on this first side, wherein a second side is hinged to the first side, wherein a vacuum motor, housed within the brush, pulls air and other debris through said holes.

3. A device comprising a brush, a handle, and bristles, wherein the bristles are connected to a first side of the brush, wherein holes are present on this first side, wherein the handle is present on a second side, wherein a vacuum motor, housed within the brush between the first and second side, pulls air and other debris through said holes, wherein a door is present in the second side to empty debris.
